(19) United States
(12) Patent Application Publication
(10) Pub. No.: US 2017/0008010 A1
(43) Pub. Date: Jan. 12, 2017

(54) Method and System of Sorting Municipal Solid Waste

(71) Applicant: Isadora Josefina Vizcaino Hernandez, Caracas (VE)

(72) Inventor: Isadora Josefina Vizcaino Hernandez, Caracas (VE)

(21) Appl. No.: 15/205,714

(22) Filed: Jul. 8, 2016

Related U.S. Application Data
(60) Provisional application No. 62/190,176, filed on Jul. 8, 2015.

(51) Int. Cl. B03C 7/00; B03C 7/08; B02C 23/08

(52) U.S. Cl. CPC B03C 7/006; B02C 23/08; B03C 7/08; B02C 2201/06

(57) ABSTRACT

A method of sorting municipal solid waste by creating a frictional force in refuse particulate using at least one frictional roller assembly to electrically charge waste material in the refuse particulate, and separating the waste material using an electrostatic force. A system of sorting municipal solid waste, including at least one frictional roller to electrically charge a waste material contained within refuse particulate, and at least one electrostatic separator to separate the waste material from the refuse particulate.

### CROSS-REFERENCE TO RELATED APPLICATIONS

This patent application claims the benefit under 35 U.S.C. §119(e) of U.S. Provisional Patent Application No. 62/190,176, filed on Jul. 8, 2015, which is incorporated herein by reference.

### FIELD OF THE INVENTION

The invention broadly relates to a method and system of sorting solid waste materials, more specifically to a method and system of sorting municipal solid waste using triboelectricity.

### BACKGROUND OF THE INVENTION

A key function of municipalities is the removal and relocation of solid waste from residential and commercial properties. Historically, municipal waste was removed from residential and commercial properties and relocated to landfills. Recently, municipalities and the public at large have made a conscious effort to become more environmentally friendly in discarding municipal waste.

Some municipalities have instituted targeted recycling programs at the consumer level to reduce waste going into landfills. This allows consumers to presort waste into general waste and recyclable waste trash receptacles, thereby providing a more efficient method and system to sort recyclable waste from non-recyclable waste. Certain municipalities presently use manual separation post collection. However, the facilities do not use the triboelectric effect to separate and sort a myriad of mixed materials.

However, not all municipalities have the resources to implement a recycling program within their territories. Residents without recycling programs discard all waste, including materials that could be recycled, into one trash receptacle. This results in discarded trash that could otherwise be used for post consumer recycling. In addition, even where municipalities have recycling programs, not all residents choose to participate. For various reasons, such as time and effort, residents continue to throw all trash into a single trash receptacle, despite the availability of a separate recycling receptacle.

Municipalities have used triboelectricity to sort mixed municipal solid waste but in a different manner. Triboelectricity is a process in which contact electrification in certain materials become electrically charged due to the friction and contact with a different material. A common example of triboelectricity is static electricity. Rubbing different materials together inside a mixer to exchange electron charges has been used to sort specific materials in a single iteration (e.g., plastic). A similar process is used in the mining industry to separate non-sulfide minerals, including minerals such as rutile, ilmenite, and monazite with magnetico-gravimetric separation in conjunction with triboelectricity.

Present municipal solid waste facilities using a triboelectric effect by electrostatic induction or contact, not by rubbing. They do not use a rubbing procedure with different materials with varying electrical behavior characteristics to allow electron transfer of the materials needed to be separated to achieve the attraction and eventual separation of the materials. Presently, facilities cannot separate waste in the same chamber for the following materials: glass, paper, metals, and plastics. The present invention permits the separation of textile materials, wood, rubber, and ceramics using a process of rubbing specific materials together to lose or gain electrons.

As can be derived from the need to recycle post consumer materials, many means have been contemplated to accomplish the desired end, i.e., separating recyclable materials that are mixed with general municipal waste. Thus, there is a long-felt need for a method and system of sorting solid waste materials. There is a further long-felt need for a method and system of sorting municipal solid waste using triboelectricity with rubbing.

### BRIEF SUMMARY OF THE INVENTION

The present invention broadly comprises a process and system of separating solid waste triboelectric effect by rubbing with electrically opposing material, that permits the excitation of charges for attraction of mixed materials to be separated. The process of steam cleaning, artificial drying, crushing, dry conditions with a preferred humidity at 20%, are the preferred conditions to achieve material separation using triboelectricity.

In a further embodiment, the present invention includes a method of sorting municipal solid waste, including creating a frictional force in refuse particulate using at least one frictional roller assembly to electrically charge at least one waste material, i.e. material to be sorted, in the refuse particulate, and separating the at least one waste material using an electrostatic force.

In another embodiment, the present invention includes a system of sorting municipal solid waste, including at least one frictional roller assembly to electrically charge a waste material contained within refuse particulate, and at least one electrostatic separator to separate the waste material from the refuse particulate.

In yet another embodiment, the present invention includes a system of sorting municipal solid waste, including a first roller assembly to charge a first waste material within mixed waste materials using a triboelectric effect, and a first separator for removing the first waste material from the mixed waste materials.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a perspective view of the present invention.

FIG. 2 is a perspective view of the frictional roller assembly of the present invention.

FIG. 3 is a perspective view of the frictional roller assembly frame, base, and junction of the present invention.

FIG. 4 is a perspective view of the roller support and roller of the frictional roller assembly of the present invention.

FIG. 5 is a bottom perspective view of the electrostatic separator of the present invention.

FIG. 6 is a top perspective view of the electrostatic separator of the present invention.

FIG. 7 is a flowchart of the present invention.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. It should be appreciated that the term “waste materials” is synonymous with terms such as “garbage”, “refuse”, “waste”, “debris”, “trash”, “junk”, etc., and such terms may be used interchangeably as appearing in the specification and claims. Although any methods, devices or materials similar or equivalent to those described herein can be used in the practice or testing of the invention, the preferred methods, devices, and materials are now described.

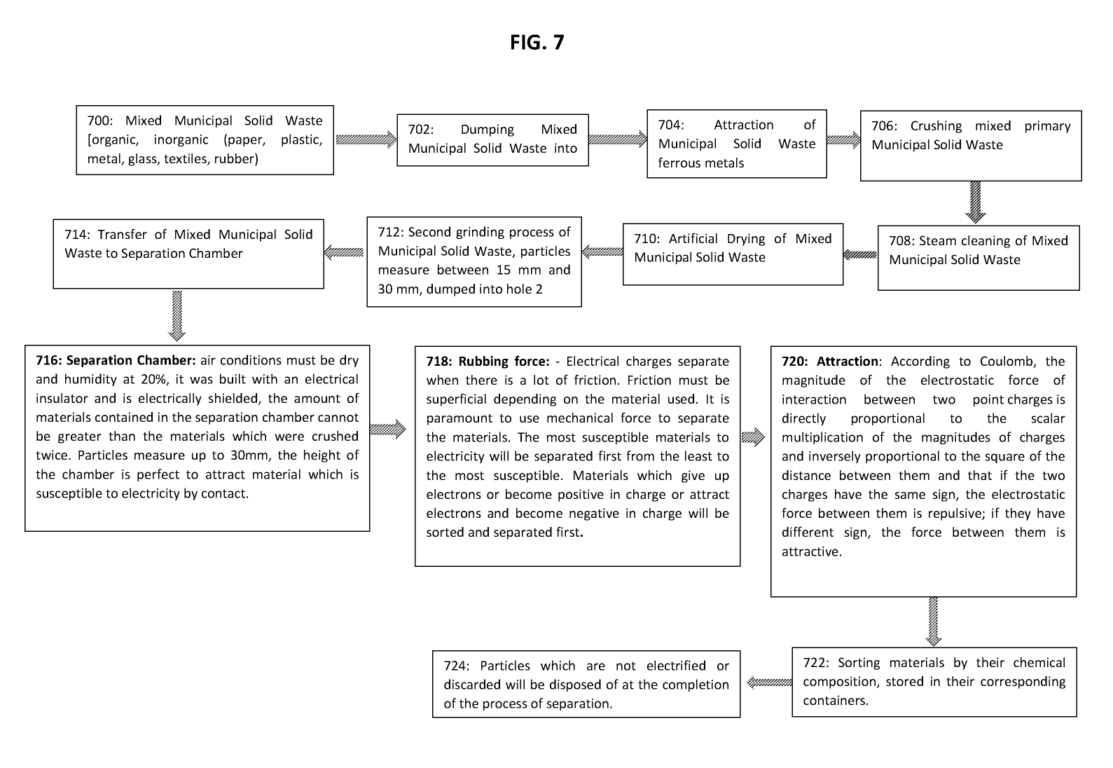

FIG. 7 illustrates the process of sorting municipal solid waste using triboelectricity. In Step 700, the mixed municipal waste is gathered. Common sources include waste management companies collecting refuse, garbage, and other waste materials from residential and commercial properties and businesses. Municipalities include, but are not limited to, cities, counties, townships, states, and unincorporated areas. Although municipal is used to identify governmental sources of waste, the waste is gathered from non-municipal sources as well, such as industry and directly from residential properties. Waste material is commonly collected using garbage trucks but a variety of sources are used to transport waste materials.

In Step 702, the municipal waste materials are removed from the garbage trucks and placed into a holding chamber. The holding chamber is any enclosure large enough to accommodate the volume of waste materials accumulated in Step 700. In Step 704, ferrous metals in the municipal waste are gathered using a magnetic source. Ferrous metals include metals that have iron and have magnetic properties, such as steel and iron alloy. Ferrous metals are separated early in the process as they are removed with known magnets given ferrous metals' magnetic properties. Removing ferrous materials in Step 704 reduces the amount of waste materials included in the sorting process of the present invention.

In Step 706, the remaining municipal waste materials are crushed into pieces, which result in mixed pieces of municipal waste materials. The primary crushing operation uses a jaw crusher. Next, in Step 708, the mixed municipal waste is steamed to clean all debris and foreign objects from the waste materials, resulting in cleaned waste materials. The steam time is determined by type the type of waste materials, in addition to temperature and pressure. Steaming the waste materials results in clean waste materials that are sterilized with a reduced or eliminated odor. These waste materials are easily separable and recoverable while in a wet state. In Step 710, a rotary dryer dries the solid waste. Using a rotary dryer avoids the risk of introducing chemical and/or biological contamination to the waste materials after the cleaning process.

Once the waste materials are steamed and dried, they are crushed in a second crushing operation, i.e. Step 712. This secondary crushing operation uses shears or cutters to achieve the necessary particulate size. Steps 706 and 708 can use other known crushing operations to reduce the size of the particulate. The second crushing process reduces the waste particles to sizes to a preferable range of 15 mm to 30 mm, also referred to as refuse particulate. Although this is the preferable size range, other ranges are acceptable by varying other conditions in the process. During this second crushing process, small particles, such as small portions of broken glass, are separated from the main waste materials. The refuse particulate includes a variety of materials, both materials to be sorted using the present invention and materials that will not be sorted and collected as end waste.

In Step 714, the refuse particulate is transferred to a separation chamber using an angled duct. Utilizing the natural force of gravity, the waste materials are sent through a duct that has an inclination angle of 45 degrees, to the separation chamber. The refuse particulate settles in the separation chamber, where environmental conditions are dry and humidity is optimally set at a 20%. Other embodiments of the invention include varying humidity levels. A 20% humidity level is the preferable humidity level but other humidity levels can be used by altering other aspects of the process. The waste materials acclimate in the ambient air with the applicable humidity level. The humidity level and atmospheric conditions provide the optimum conditions for separating the waste materials using the present invention.

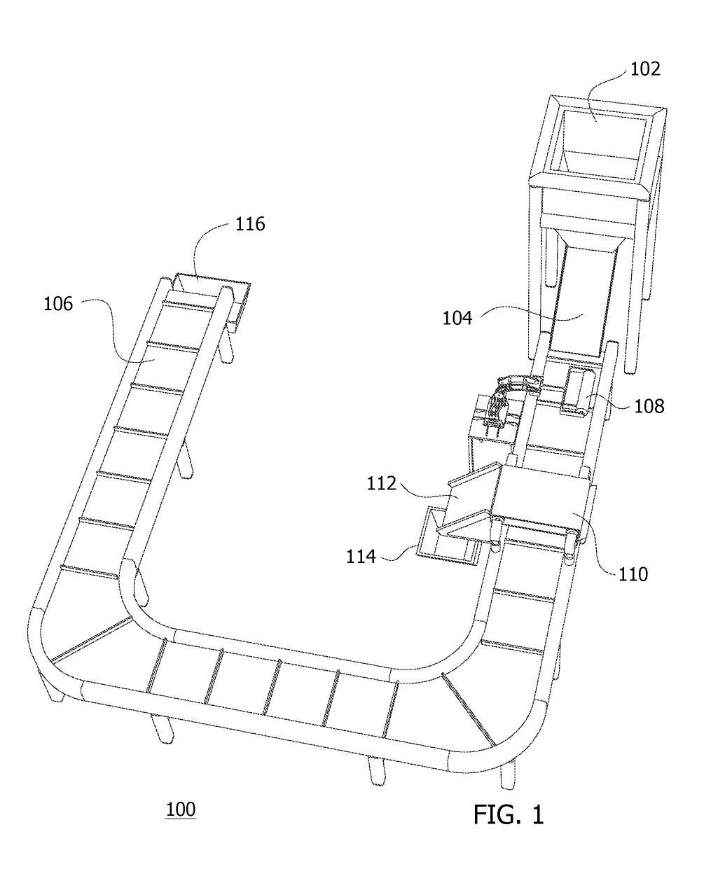

Once the refuse particulate is at the desired environmental conditions, the refuse particulate is loaded into a hopper 102 on the separator system 100 as shown in FIG. 1. The refuse particulate then travels on hopper slide 104 onto a conveyer 106 or similar transport system. Conveyer 106 includes rail separators to gather a certain amount of refuse particulate in each section of the conveyer 106.

The hopper 102 in Step 716 includes an electrical insulator and is electrically shielded. The refuse particulate from Steps 706 and 712 is held in hopper 102. As the refuse particulate exits hopper 102 onto hopper slide 104 and the conveyer 106, more refuse particulate is loaded into hopper 102 either continuously or using pre-sized batches based on the volume of the hopper 102. Waste material particles measure up to 30 mm in the preferred embodiment of the invention.

The triboelectric effect, also referred to as the triboelectric charging, is a type of contact electrification wherein certain materials become electrically charged after they come into frictive contact with a different material. Common examples include rubbing glass with fur or running a comb through hair. Most static electricity is triboelectric. The physical interaction between two materials, such as rubbing and frictive contact, generates an electric charge. The contact, which occurs numerous times, increases the triboeletric effect.

In Step 718, electrical charges separate due increased frictive contact. Based on the waste materials involved, superficial friction is used. Mechanical force is preferable and optimal to separate a specific waste material from refuse particulate. The waste material most susceptible to electricity is separated first using a frictional roller assembly 108. Then various waste materials are removed based on their susceptibility to electricity, finishing with the least susceptible to electricity. Waste material that gives up electrons and become positive in charge, or that attracts electrons and become negative in charge, are sorted and separated first.

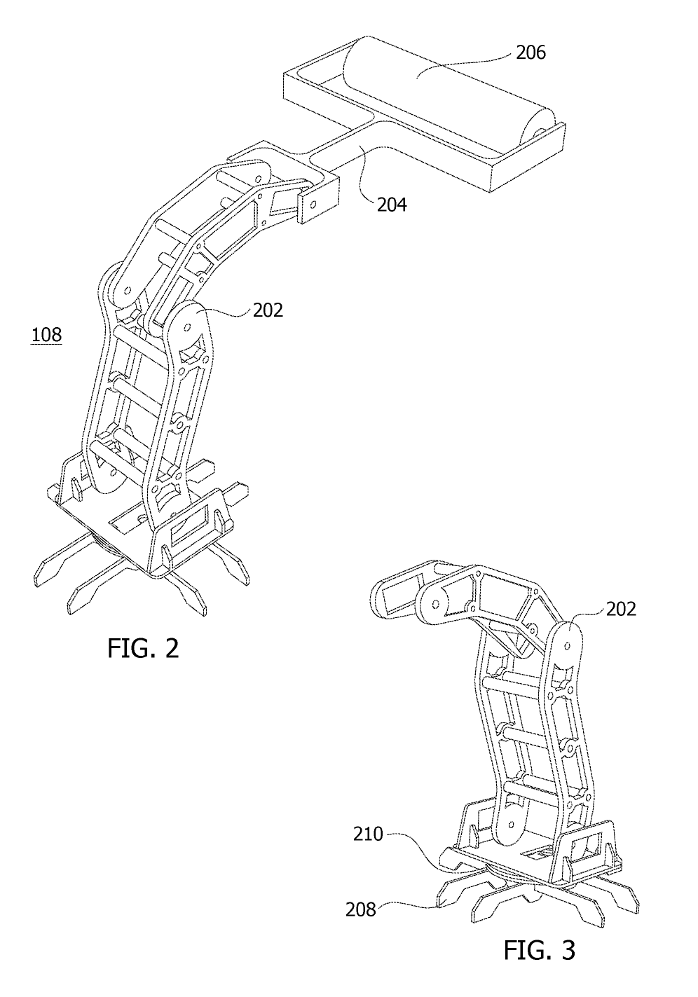

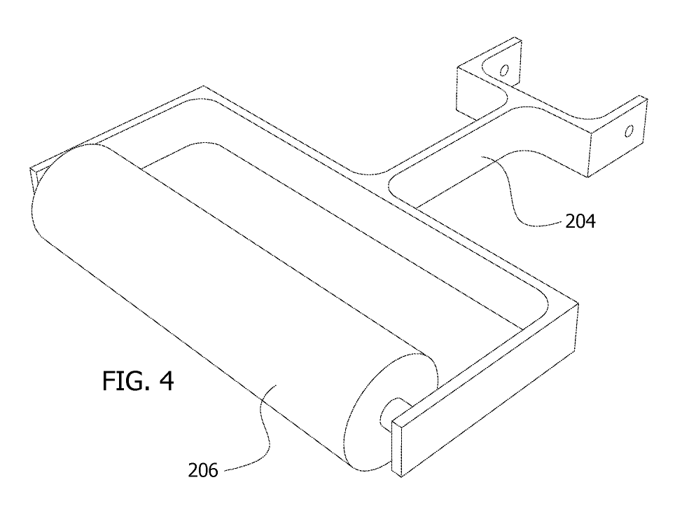

As shown in FIGS. 2, 3, and 4, frictional roller assembly 108 includes assembly frame 202, roller support 204, and roller 206. A material exchanger is secured to roller 206. The material exchanger is removed and changed on roller 206 based on the type of waste material that is to be removed from the refuse particulate. Multiple rollers 206 are used when sorting different waste materials using their respective material exchanger. Table 1 shows the materials required to create the required triboelectric effect to separate a specific waste material from refuse particulate.

As shown in FIG. 1, frictional roller assembly 108 is positioned on a stand next to conveyer 106. Assembly base 208 of the frictional roller assembly is secured to the stand. Assembly frame 202 rotates about assembly base 208 at junction 210. The rotation of the frictional roller assembly allows for optimal positioning of roller 206 above the refuse particulate on conveyer 106. Although junction 210 is shown with rotational movement, similar known adjustment mechanisms can be used to properly position frictional rollers assembly 108 above conveyer 106.

Different types of material exchangers are installed on roller 206 depending on the type of waste material being separated from the refuse particulate. Table 1 highlights different material exchangers (rubbing material) to be used to separate the waste material from the refuse particulate. The preferred height between the material exchanger on roller 206 and the refuse particulate on conveyer 106 is six to eight inches. The optimal height depends on the specific material exchanger being used to separate the waste material from the refuse particulate.

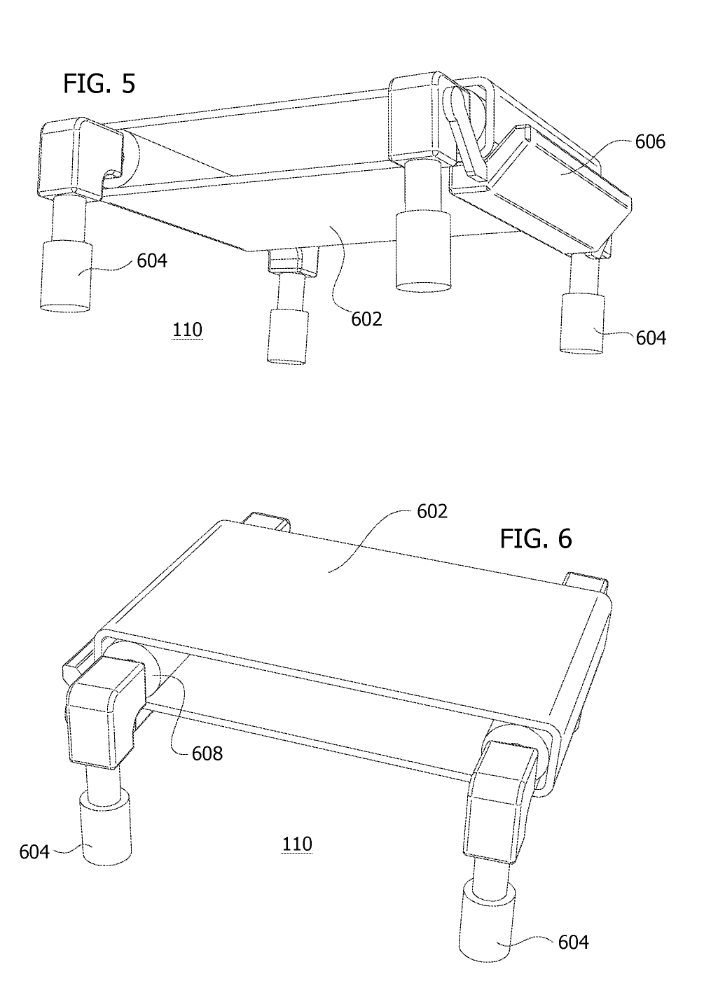

In Step 720, the refuse particulate become attracted to each other due to the frictive contact in Step 718. As shown in FIG. 1, electrostatic separator 110 is positioned directly after the frictional roller assembly 108 on conveyer 106. FIGS. 5 and 6 show electrostatic separator 110, which includes: attracting material 602, leg supports 604, guard 606, and attracting friction rollers 608.

Leg supports 604, of which there are four in this configuration, support the electrostatic separator 110 on conveyer 106. Attracting material 602 is positioned above the conveyer 106. Attracting material 602 rotates about attracting friction rollers 608 to create an electrical charge to attract the specific waste material that was previously charged using frictional roller assembly 108.

Based on Coulomb's law, a law of physics describing the electrostatic interaction between electrically charged particles, the magnitude of the electrostatic force of interaction between two point charges is directly proportional to the scalar multiplication of the charge magnitude, and inversely proportional to the squared distance between them. When the two charges have the same electrical sign, the electrostatic force between them is repulsive. When the two charges have different electrical signs, the force between them is attractive.

Each type of waste material reacts differently when making frictive contact with other materials within the refuse particulate. There are several variables to monitor while the materials and making contact. Depending on the type of waste material, the applied friction force either makes materials give up electrons and become positive in charge or attract electrons and become negative in charge. Friction should be applied superficially, depending on the material type. The temperature of friction force should not the temperature of the materials being rubbed together. Mechanical force, using pneumatic pistons, is the preferable mechanism to achieve the ideal friction force. The rubbing of materials is done gradually and constantly.

To separate the various solid waste types, different forces are applied to materials that give up electrons, e.g. glass, paper, and aluminum, as well as to those that attract electrons, e.g. plastic, gold, platinum, bronze, and silver. The attraction of the materials is achieved using opposite electrical charges. Coulomb's theory is used to calculate the electrostatic force necessary to achieve the attraction.

Coulomb's Law states that the magnitude of the electrostatic force of interaction between two point charges is directly proportional to the scalar multiplication of the magnitudes of charges and inversely proportional to the square of the distance between them. If the two charges have the same sign, the electrostatic force between them is repulsive; if they have different sign, the force between them is attractive. Furthermore, the shorter the distance between the charges the greater the electrostatic force, which is the force necessary to attract the materials that the present invention separates. Known as force of attraction, this force must be greater than or equal to the total of the electrostatic force stated by Coulomb plus the gravitational force and the weight of the materials which will be attracted.

Determining the weight of each particle is not exact. To achieve the attraction of materials, the weight is calculated by the molar mass of each waste type and size of the particle. In fact, this calculation determines what the best and biggest size of the particle is. The distance of attraction is determined by separating materials that have the same electrical charge. The distance plus the electrostatic force defines the attraction of the material that is separated. It is defined as follows: FA≧FE+FG. In the mixer, smaller and lighter loads of materials that are susceptible of electrifying and releasing charges quicker than others are capable of travelling longer distances than bigger and heavier loads.

In Step 722, the waste material collected on attracting material 602 is deposited onto separator slide 112 and collected in container 114. Each respective waste material sorted is collected into its own respective container 114, depending on their electrostatic charge and chemical composition. Chemical composition refers to the periodic table of elements, which aid in grouping similar materials together, e.g., glass, metal, plastic, paper, etc. Each grouping corresponds to an electrostatic charge table with a defined positive or negative electrical charge for the grouping.

To unload the sorted waste materials into their corresponding containers 114 and to remove their electric charge, electrical circuits are connected to a grounded source. In addition, the respective containers 114 are electrically shielded. Electrical circuits are connected to the ground at the beginning of every process of material separation.

Lastly, in Step 724, the particles that are not electrified or discarded are disposed of at the completion of the process of separation in final refuse container 116, as shown in FIG. 1.

The overall process works by exciting electrons to make the silk materials, as an example, lose electrons (become positive) or gain electrons (become negative) to achieve the attraction of silk materials with other materials that are oppositely charged.

First, the materials need specific conditions to achieve the goal of separation using the triboelectric effect: grinding, cleaning, drying, and conditioned dry air with relative humidity of 20%. The materials are contained in a separation chamber with these conditions and with a relative humidity of 20%. The materials are processed as follows:

The following example shows the process for sorting the specific waste materials shown in Table 1 using the separator system 100. Refuse particulate is loaded into hopper 102. The refuse particulate, preferably ranging from 15-30 mm, is released from hopper 102 onto slide 104, which loads the refuse particulate on top conveyer 106.

For separation process A, according to Table 1, the refuse particulate on conveyer 106 travels under a first frictional roller assembly. In process A, glass is the target waste material to be separated from the refuse particulate. The roller of the first frictional roller assembly is covered with silk as the material exchanger. When the refuse material passes under the first frictional roller assembly, the refuse materials are electrically charged.

Next, the refuse particulate on the conveyer travels to the first electrostatic separator. For process A, the first electrostatic separator includes polyvinyl chloride (PVC) or Vinyl as the attracting material (602). The attracting friction rollers are made of leather. The interaction between the PVC and leather create an attractive force that specifically targets the glass waste material in the refuse particulate. The glass waste material separated using the first electrostatic separator travels onto the first separator slide and into the first container.

For separation process B, according to Table 1, the remaining refuse particulate on conveyer 106 travels under a second frictional roller assembly. In process B, paper is the target waste material to be separated from the refuse particulate. The roller of the second frictional roller assembly is covered with Teflon as the material exchanger. When the refuse material passes under the second frictional roller assembly, the refuse materials are electrically charged.

Next, the refuse particulate on the conveyer travels to the second electrostatic separator. For process B, the second electrostatic separator includes ebonite as the attracting material (602). The attracting friction rollers are made of leather. The interaction between the ebonite and leather create an attractive force that specifically targets the paper waste material in the refuse particulate. The paper waste material separated using the second electrostatic separator travels onto the second separator slide and into the second container.

For separation process C, according to Table 1, the remaining refuse particulate on conveyer 106 travels under a third frictional roller assembly. In process C, aluminum is the target waste material to be separated from the refuse particulate. The roller of the third frictional roller assembly is covered with Teflon as the material exchanger. When the refuse material passes under the third frictional roller assembly, the refuse materials are electrically charged.

Next, the refuse particulate on the conveyer travels to the third electrostatic separator. For process C, the third electrostatic separator includes silicone rubber as the attracting material (602). The attracting friction rollers are made of leather. The interaction between the silicone rubber and leather create an attractive force that specifically targets the aluminum waste material in the refuse particulate. The aluminum waste material separated using the third electrostatic separator travels onto the third separator slide and into the third container.

For separation process D, according to Table 1, the remaining refuse particulate on conveyer 106 travels under a fourth frictional roller assembly. In process D, plastic is the target waste material to be separated from the refuse particulate. The roller of the fourth frictional roller assembly is covered with nylon as the material exchanger. When the refuse material passes under the fourth frictional roller assembly, the refuse materials are electrically charged.

Next, the refuse particulate on the conveyer travels to the fourth electrostatic separator. For process D, the fourth electrostatic separator includes leather as the attracting material (602). The attracting friction rollers are made of polyester. The interaction between the leather and polyester create an attractive force that specifically targets the plastic waste material in the refuse particulate. The plastic waste material separated using the fourth electrostatic separator travels onto the fourth separator slide and into the fourth container. Any refuse particulate that remains on conveyer 106 is deposited into final refuse container.

Although the preceding example shows the separation of glass, paper, aluminum, and then plastic, it should be noted that the order of the waste material to be sorted depends on the electrical properties of the materials to be sorted. The order of the waste materials separated on conveyer 106 varies.

In another exemplary embodiment showing Process A, glass is rubbed mechanically using pneumatic cylinders manufactured with silk at their ends. The rubbing motion is tangential to the surface of the glass and all of the mixed waste materials. All waste materials in Process A are rubbed with the same material, but only the glass reacts since the other materials are not attracted electrically to the silk. Next, the attracting material (PVC or Vinyl) is rubbed with the material exchanger (silk) to achieve a better charge attractant for this material that is negatively charged. In this example, panels constructed with the attracting materials and rubbed with the material exchanger for attracting material, the attracting material is PVC rubbed with leather. This results in the PVC gaining electrons and becoming negatively charged.

The panels that contain the attracting materials are placed next to the mixture of mixed waste particulate. This attracts the glass materials in the waste mixture down the duct with a 45 degree decline into separate containers to detach the electrified materials from the panels with attracting materials. The separated mixture must be discharged by grounding to proceed to the next iteration of rubbing the remaining materials, as specified in Table 1. Measurements and values are determined for optimal friction force or friction necessary depending on the material being attracted. The measures and values being determined for optimum strength values are the friction or rubbing required to induce electrical charge to achieve the strength to achieve optimum electrostatic attraction, without spark discharge. The distance between the mixed material and attraction panels is called snap distance, which varies and is another measured to determine.

The next step is for susceptible materials to gain electrons that are negatively charged from the most susceptible to less susceptible, in the following order, with the following materials:

The procedure is repeated the same way as in the previous case for the remaining materials.

In yet another exemplary embodiment, the present invention provides a system of sorting municipal solid waste, including a holding chamber for waste materials, a means of crushing waste materials into waste material particulate, a steamer to sanitize waste material particulate, a dryer to dry waste material particulate, at least one rubbing material mixed with waste material particulate, at least one panel with a material to attract waste material particulate, at least one duct for separating the waste material particulate, and at least one separation chamber to store separated waste material particulate.

In another exemplary embodiment of the invention, a conveyer transports refuse particles through a system to electrostatically separate specific waste materials from the refuse particles. The refuse particles pass under a frictional roller assembly, which electrically charges a targeted type of waste material contained within refuse particulate. Then, the conveyer moves the refuse particles under an electrostatic separator to separate the targeted waste material from the refuse particulate. The targeted waste material is removed from the electrostatic separator into a separation chamber that only contains the targeted waste material. Additional pairs of frictional roller assemblies and electrostatic separators, paired accordingly, are used to further sort additional targeted waste materials.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What I claim is:

1. A method of sorting municipal solid waste, comprising:
creating a frictional force in refuse particulate using at least one frictional roller assembly to electrically charge at least one waste material in the refuse particulate; and
separating the at least one waste material using an electrostatic force.

2. The method of sorting municipal solid waste recited in claim 1, wherein the electrostatic force is triboelectric.

3. The method of sorting municipal solid waste recited in claim 2, wherein the material exchanger is removably secured to the roller.

4. The method of sorting municipal solid waste recited in claim 1, wherein the frictional roller assembly includes: a material exchanger, a roller, a roller support, and an assembly frame.

5. The method of sorting municipal solid waste recited in claim 4, wherein the assembly frame rotates about an assembly base.

6. The method of sorting municipal solid waste recited in claim 1, further comprising:
crushing refuse particulate;
transporting refuse particulate; and
sorting refuse particulate.

7. A system of sorting municipal solid waste, comprising:
at least one frictional roller assembly to electrically charge a waste material contained within refuse particulate; and
at least one electrostatic separator to separate the waste material from the refuse particulate.

8. The system of sorting municipal solid waste as recited in claim 7 wherein the frictional roller assembly uses a triboelectric effect to electrically charge the waste material.

9. The system of sorting municipal solid waste as recited in claim 7, further comprising a conveyer to transport the refuse particles.

10. The system of sorting municipal solid waste as recited in claim 8, wherein the electrostatic separator separates the waste material from the refuse particulate on a conveyer.

11. The system of sorting municipal solid waste as recited in claim 7, further comprising a separation chamber to store the waste material collected from the electrostatic separator.

12. A system of sorting municipal solid waste, comprising:
a first roller assembly to charge a first waste material within mixed waste materials using a triboelectric effect; and
a first separator for removing the first waste material from the mixed waste materials.

13. The system of sorting municipal solid waste as recited in claim 12, further comprising:
a second roller assembly to charge a second waste material within mixed waste materials using a triboelectric effect; and
a second separator for removing the second waste material from the mixed waste materials.

14. The system of sorting municipal solid waste as recited in claim 13, further comprising:
a third roller assembly to charge a third waste material within mixed waste materials using a triboelectric effect; and
a third separator for removing the third waste material from the mixed waste materials.

15. The system of sorting municipal solid waste as recited in claim 14, further comprising:
a fourth roller assembly to charge a fourth waste material within mixed waste materials using a triboelectric effect; and
a fourth separator for removing the fourth waste material from the mixed waste materials.
